(19) United States
(12) Patent Application Publication
(10) Pub. No.: US 2022/0408655 A1
(43) Pub. Date: Dec. 29, 2022

(54) HEDGE TRIMMER

(71) Applicant: MILWAUKEE ELECTRIC TOOL CORPORATION, Brookfield, WI (US)

(72) Inventors: Gerald A. Zucca, Milwaukee, WI (US); Vincent M. Zornow, Milwaukee, WI (US); Nathan Bandy, Wauwatosa, WI (US); John Jubeck, Mequon, WI (US); Andrew J. Weber, Cudahy, WI (US); Marcus Wechselberger, Milwaukee, WI (US); Jacob N. Zimmerman, Pewaukee, WI (US); Katherine G. Stringfield, Wauwatosa, WI (US)

(21) Appl. No.: 17/809,527

(22) Filed: Jun. 28, 2022

Related U.S. Application Data
(60) Provisional application No. 63/215,636, filed on Jun. 28, 2021.
(60) Provisional application No. 63/246,170, filed on Sep. 20, 2021.

(51) Int. Cl. A01G 3/053

(52) U.S. Cl. CPC A01G 3/053; A01G 2003/0461

(57) ABSTRACT

An outdoor device comprising: a first blade comprising a first blade opening at a proximal end; a second blade comprising a second blade opening at a proximal end; a first cam coin comprising a first cam coin opening; a second cam coin comprising a second cam coin opening; an output gear comprising an output gear opening; and an output shaft comprising a first portion and a second portion, the first portion wider than the respective openings, the second portion wider than the output gear opening, wherein the respective openings are aligned to form a cam assembly, and wherein the output shaft is positioned through the respective aligned openings such that the cam assembly is positioned at a perpendicular plane respective to the second portion and supported for rotation about an axis to rotate eccentrically with respect to the output shaft axis.

### RELATED APPLICATIONS

This application claims the benefit of U.S. Provisional Patent Application No. 63/215,636, filed Jun. 28, 2021, and U.S. Provisional Patent Application No. 63/246,170, filed Sep. 20, 2021, the entire content of each of which is hereby incorporated by reference.

### BACKGROUND

Outdoor tools, such as hedge trimmers, are used for performing outdoor tasks, such as trimming hedges.

### SUMMARY

In some aspects, disclosed herein, are outdoor tools, such as a hedge trimmer. These outdoor tools include a first blade including a first blade opening at a proximal end, a second blade including a second blade opening at a proximal end, a first cam coin including a first cam coin opening, and a second cam coin including a second cam coin opening. The outdoor tools also include an output gear comprising an output gear opening, and an output shaft including a first portion and a second portion. The first portion is wider than the respective openings. The second portion is wider than the output gear opening.

In some embodiments, the respective openings are aligned to form a cam assembly. In some embodiments, the output shaft is positioned through the respective aligned openings such that the cam assembly is positioned at a perpendicular plane respective to the second portion and supported for rotation about an axis to rotate eccentrically with respect to the output shaft axis. In some embodiments, the output shaft is positioned such that the first portion supports the cam assembly and the second portion supports the output gear. In some embodiments, the first cam coin and the second cam coin are positioned 180 degrees apart respective to the output shaft and each's respective cam coin opening. In some embodiments, the first proximal end of the first blade and the second proximal end of the second blade each comprise two stacked layers and an ear portion that extends beyond the cam assembly.

In some embodiments, a hedge trimmer includes a cam cover comprising a cover opening, and a slide cam washer including a slide cam opening. In some embodiments, the cover opening and the slide cam opening are aligned with the opening to form the cam assembly. In some embodiments, the output shaft is positioned through the respective aligned openings. In some embodiments, the cam cover is adjacent to a surface to the first portion. In some embodiments, the first cam coin is adjacent to the cam cover. In some embodiments, the proximal end of the first blade is adjacent to the first cam coin. In some embodiments, the slide cam washer is adjacent to the proximal end of the first blade. In some embodiments, the proximal end of the second blade is adjacent to the slide cam washer. In some embodiments, the second cam coin is adjacent to the proximal end of the second blade. In some embodiments, the output gear is adjacent to the second cam coin. In some embodiments, the cam assembly is configured to rigidly mount the first blade and the second blade to keep the blades from disengaging.

In some embodiments, a hedge trimmer includes a motor coupled to an output gear. In some embodiments, the output gear is configured to transmit forces generated by the motor to rotate the output shaft. In some embodiments, the motor is configured to operate in a forward rotational direction or a reverse rotational direction. In some embodiments, the motor is configured to alternate between the forward rotational direction and the reverse rotational direction based on a cycling of an input signal.

In some embodiments, a hedge trimmer includes a trigger switch. In some embodiments, an input signal is received from the trigger switch. In some embodiments, the input signal includes an electric current or voltage. In some embodiments, the hedge trimmer includes a controller coupled to the motor and the controller includes one or more processors and a non-transitory computer readable medium coupled to the one or more processors and having instructions stored thereon which, when executed by the one or more processors, cause the one or more processors to perform operations that include receiving the input signal and alternating the rotational direction of the motor based on the received input. In some embodiments, a hedge trimmer includes a butterfly switch configured to lock the trigger switch.

In some embodiments, a hedge trimmer includes a housing and a battery. In some embodiments, the battery is isolated from the motor in the housing and configured to supply power to the motor. In some embodiments, the motor is mounted within a handle portion of the housing. In some embodiments, the motor includes a brushless motor. In some embodiments, the first blade and the second blade are eight-inch blades.

In some embodiments, a hedge trimmer includes a gear case. In some embodiments, a cam assembly is bolted to the gear case. In some embodiments, a hedge trimmer includes a gear case cover coupled to the gear case. In some embodiments, the gear case cover is formed with a material reduction pattern and includes an integrated hand hook feature. In some embodiments, the first blade and the second blade are configurable to a fanned position. In some embodiments, the cam assembly is configured to remain intact when the first blade and the second blade are in the fanned position. In some embodiments, the hedge trimmer includes a fully enclosed blade sheath to protect the first blade and the second blade.

In some embodiments, the hedge trimmer includes a blade assembly including a first blade, a second blade, a blade spine, and a plurality of bushings. In some embodiments, the first blade and the second blade are affixed to the blade spine. In some embodiments, the bushings are stationary with respect to the blade spine and allow for reciprocating motion between the first blade and the second blade. In some embodiments, the blade assembly is secured to the gear case via blade mounting screws. In some embodiments, the blade assembly that includes a peanut shaped bushing. In some embodiments, the blade mounting screws are secured to the gear case via a respective fastener. In some embodiments, the fasteners are hexagonal nuts.

In another aspect, disclosed herein, are methods for operating a hedge trimmer that includes a trigger switch and a motor. The methods include detecting a first actuation of the trigger switch, rotating the motor in a first direction, detecting a release of the trigger switch, stopping the rotation of the motor, detecting a second actuation of the trigger switch, and rotating the motor in a second direction opposite the first direction.

In some embodiments, the methods include storing a next direction or a previous direction of the motor in a counter or a binary value. In some embodiments, the direction of the motor is determined based on the stored direction. In some embodiments, the hedge trimmer includes a first blade including a first blade opening at a proximal end, a second blade including a second blade opening at a proximal end, a first cam coin including a first cam coin opening, a second cam coin including a second cam coin opening, an output gear including an output gear opening, and an output shaft including a first portion and a second portion. The first portion is wider than the respective openings, and the second portion is wider than the output gear opening.

In some embodiments, the respective openings are aligned to form a cam assembly. In some embodiments, the output shaft is positioned through the respective aligned openings such that the cam assembly is positioned at a perpendicular plane respective to the second portion and supported for rotation about an axis to rotate eccentrically with respect to the output shaft axis. In some embodiments, the output shaft is positioned such that the first portion supports the cam assembly, and the second portion supports the output gear. In some embodiments, the first cam coin and the second cam coin are positioned 180 degrees apart respective to the output shaft and each cam's respective cam coin opening. In some embodiments, the first proximal end of the first blade and the second proximal end of the second blade each comprise two stacked layers and an ear portion that extends beyond the cam assembly.

In some embodiments, a hedge trimmer includes a cam cover including a cover opening, and a slide cam washer including a slide cam opening. In some embodiments, the cover opening and the slide cam opening are aligned with the opening to form the cam assembly. In some embodiments, the output shaft is positioned through the respective aligned openings. In some embodiments, the cam cover is adjacent to a surface to the first portion. In some embodiments, the first cam coin is adjacent to the cam cover. In some embodiments, the proximal end of the first blade is adjacent to the first cam coin. In some embodiments, the slide cam washer is adjacent to the proximal end of the first blade. In some embodiments, the proximal end of the second blade is adjacent to the slide cam washer. In some embodiments, the second cam coin is adjacent to the proximal end of the second blade. In some embodiments, the output gear is adjacent to the second cam coin. In some embodiments, the cam assembly is configured to rigidly mount the first blade and the second blade to keep the blades from disengaging. In some embodiments, the motor is couple to the output gear. In some embodiments, the output gear is configured to transmit forces generated by the motor to rotate the output shaft. In some embodiments, the motor is configured to operate in a forward rotational direction or a reverse rotational direction. In some embodiments, the motor is configured to alternate between the forward rotational direction and the reverse rotational direction based on a cycling of an input signal. In some embodiments, the input signal is received from the trigger switch. In some embodiments, the input signal includes an electric current or voltage.

In some embodiments, a hedge trimmer includes a housing and a battery. In some embodiments, the battery is isolated from the motor in the housing and configured to supply power to the motor. In some embodiments, the motor is mounted within a handle portion of the housing. In some embodiments, the motor includes a brushless motor. In some embodiments, the first blade and the second blade are eight-inch blades.

In some embodiments, the hedge trimmer includes a gear case. In some embodiments, the cam assembly is bolted to the gear case. In some embodiments, a hedge trimmer includes a gear case cover coupled to the gear case. In some embodiments, the gear case cover is formed with a material reduction pattern and includes an integrated hand hook feature. In some embodiments, the hedge trimmer includes a blade assembly including a first blade, a second blade, a blade spine, and a plurality of bushings. In some embodiments, the first blade and the second blade are affixed to the blade spine. In some embodiments, the bushings are stationary with respect to the blade spine and allow for reciprocating motion between the first blade and the second blade. In some embodiments, the first blade and the second blade are configurable to a fanned position. In some embodiments, the cam assembly is configured to remain intact when the first blade and the second blade are in the fanned position. In some embodiments, the hedge trimmer includes a fully enclosed blade sheath to protect the first blade and the second blade.

In another aspect, disclosed herein, are hedge trimmers including a trigger switch, an output gear, and a motor coupled to the output gear. The motor is configured to operate in a forward rotational direction or a reverse rotational direction. A controller is coupled to the motor and includes one or more processors and a non-transitory computer readable medium coupled to the one or more processors and having instructions stored thereon which, when executed by the one or more processors, cause the one or more processors to receive the input signal from the trigger switch, and alternate the rotational direction of the motor based on the received input. In some embodiments, a hedge trimmer includes a butterfly switch configured to lock the trigger switch. In some embodiments, the hedge trimmers include a first blade including a first blade opening at a proximal end, a second blade including a second blade opening at a proximal end, a first cam coin including a first cam coin opening, and a second cam coin including a second cam coin opening.

In some embodiments, the output gear includes an output gear opening. In some embodiments, the respective openings are aligned to form a cam assembly, and an output shaft includes a first portion and a second portion. The first portion is wider than the respective openings. The second portion is wider than the output gear opening. In some embodiments, the output gear is configured to transmit forces generated by the motor to rotate the output shaft. In some embodiments, the output shaft is positioned through the respective aligned openings such that the cam assembly is positioned at a perpendicular plane respective to the second portion and supported for rotation about an axis to rotate eccentrically with respect to the output shaft axis. In some embodiments, the output shaft is positioned such that the first portion supports the cam assembly, and the second portion supports the output gear. In some embodiments, the first cam coin and the second cam coin are positioned 180 degrees apart respective to the output shaft and each cam's respective cam coin opening.

In some embodiments, the hedge trimmers include a cam cover including a cover opening, and a slide cam washer comprising a slide cam opening. In some embodiments, the cover opening and the slide cam opening are aligned with the opening to form the cam assembly. In some embodiments, the output shaft is positioned through the respective aligned openings. In some embodiments, the cam cover is adjacent to a surface to the first portion. In some embodiments, the first cam coin is adjacent to the cam cover. In some embodiments, the proximal end of the first blade is adjacent to the first cam coin. In some embodiments, the slide cam washer is adjacent to the proximal end of the first blade. In some embodiments, the proximal end of the second blade is adjacent to the slide cam washer. In some embodiments, the second cam coin is adjacent to the proximal end of the second blade. In some embodiments, the output gear is adjacent to the second cam coin. In some embodiments, the cam assembly is configured to rigidly mount the first blade and the second blade to keep the blades from disengaging. In some embodiments, the motor is couple to the output gear. In some embodiments, the output gear is configured to transmit forces generated by the motor to rotate the output shaft. In some embodiments, the motor is configured to operate in a forward rotational direction or a reverse rotational direction. In some embodiments, the motor is configured to alternate between the forward rotational direction and the reverse rotational direction based on a cycling of an input signal. In some embodiments, the input signal is received from the trigger switch. In some embodiments, the input signal includes an electric current or voltage.

In some embodiments, hedge trimmers include a housing and a battery. In some embodiments, the battery is isolated from the motor in the housing and is configured to supply power to the motor. In some embodiments, the motor is mounted within a handle portion of the housing. In some embodiments, the motor includes a brushless motor. In some embodiments, a first blade and a second blade are eight-inch blades. In some embodiments, the hedge trimmers include a gear case. In some embodiments, the cam assembly is bolted to the gear case. In some embodiments, the hedge trimmers include a blade assembly including the first blade, the second blade, a blade spine, and a plurality of bushings. In some embodiments, the first blade and the second blade are affixed to the blade spine. In some embodiments, the bushings are stationary with respect to the blade spine and allow for reciprocating motion between the first blade and the second blade.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless otherwise defined, all technical terms used herein have the same meaning as commonly understood by one of ordinary skill in the art to which the present subject matter belongs. As used in this specification and the appended claims, the singular forms “a,” “an,” and “the” include plural references unless the context clearly dictates otherwise. Any reference to “or” herein is intended to encompass “and/or” unless otherwise stated.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other aspects of the embodiments will become apparent by consideration of the detailed description and accompanying drawings.

### BRIEF DESCRIPTION OF DRAWINGS

FIGS. 1A-1C depict an embodiment of an outdoor tool.

FIG. 1D depicts an embodiment of the outdoor tool with additional support structures on the housing for the output shaft.

FIG. 1E depicts an embodiment of the outdoor tool illustrating an orientation of the PCBA relative to the motor.

FIG. 1F depicts an embodiment of the outdoor tool illustrating a type of the trigger switch.

FIG. 1G depicts an embodiment of a bearing pocket geometry of the outdoor tool.

FIGS. 2A-2C depict a side view of embodiments of a cam assembly of the outdoor tool of FIGS. 1A-1C.

FIGS. 3A and 3B depict views of an embodiment of a cam assembly of the outdoor tool of FIGS. 1A-1C.

FIGS. 4A-4F depict an example assembly order for a cam assembly.

FIGS. 5A-5C depict an embodiment of an outdoor tool in which a cam assembly is supported for rotation.

FIGS. 6A-6C depict an embodiment of a blade assembly of the outdoor tool of FIGS. 1A-1C.

FIG. 7A depicts an embodiment of a cam assembly assembled onto the blade assembly of FIGS. 6A-6C.

FIG. 7B depicts an embodiment of a blade assembly and a cam assembly secured to a gear case.

FIG. 7C depicts embodiments of the blade assembly that includes a peanut shaped bushing that provides two contact surfaces in one bushing

FIGS. 7D and 7E depict an embodiment of the blade assembly and the cam assembly illustrating a fanned positioning of the reciprocating blades.

FIGS. 8A-8C depict an embodiment of the outdoor tool illustrating an engagement of a butterfly switch.

FIG. 9 depicts an embodiment of the gear case cover.

FIGS. 10A-10B depict an embodiment of the outdoor tool that includes a blade sheath.

FIG. 11 depicts a control system for the outdoor tool of FIGS. 1A-1C.

FIG. 12 depicts an example process for operating a hedge trimmer.

### DETAILED DESCRIPTION

Embodiments of the present disclosure are generally directed to outdoor tools, such as a hedge trimmer. More particularly, embodiments of the present disclosure are directed to outdoor tools with rigidly mounted, reciprocating blades and a user input, such as a trigger, that alternates the rotational direction of the motor.

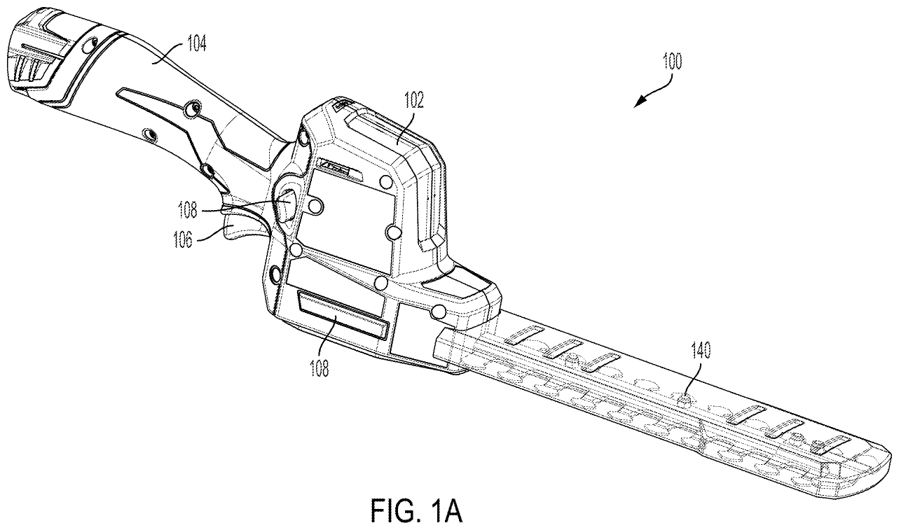

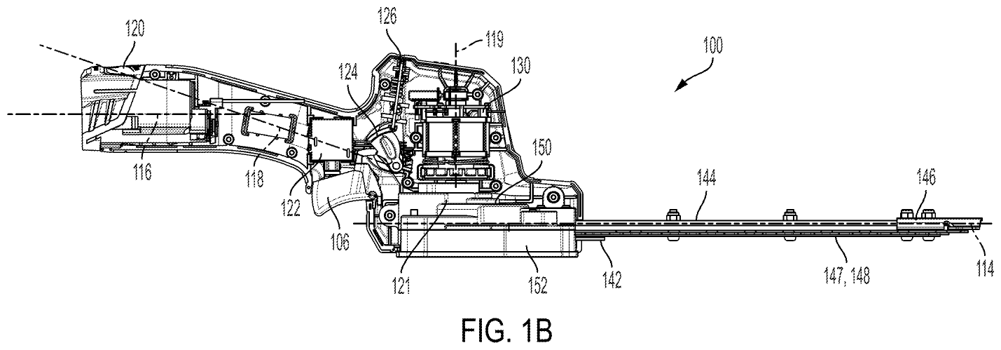

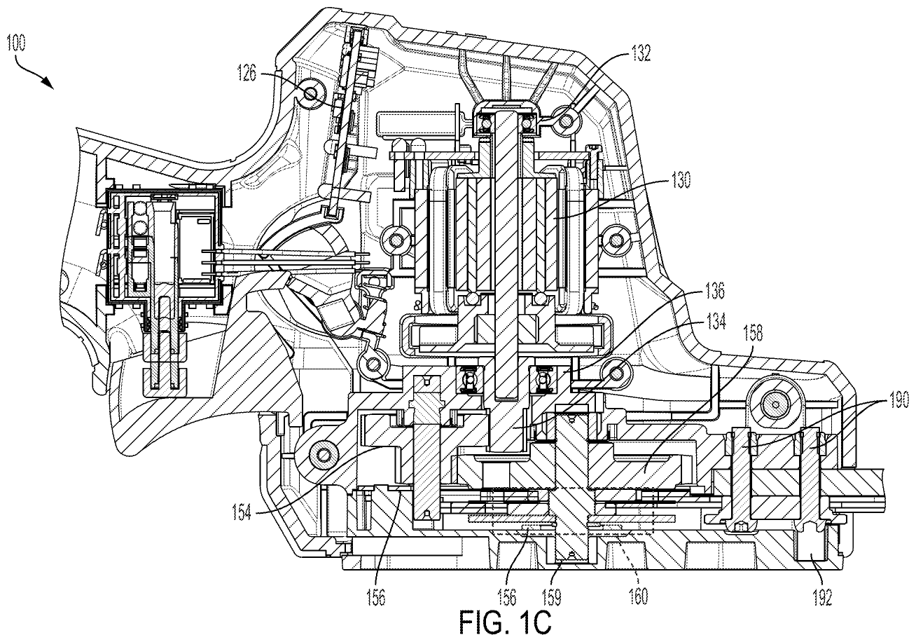

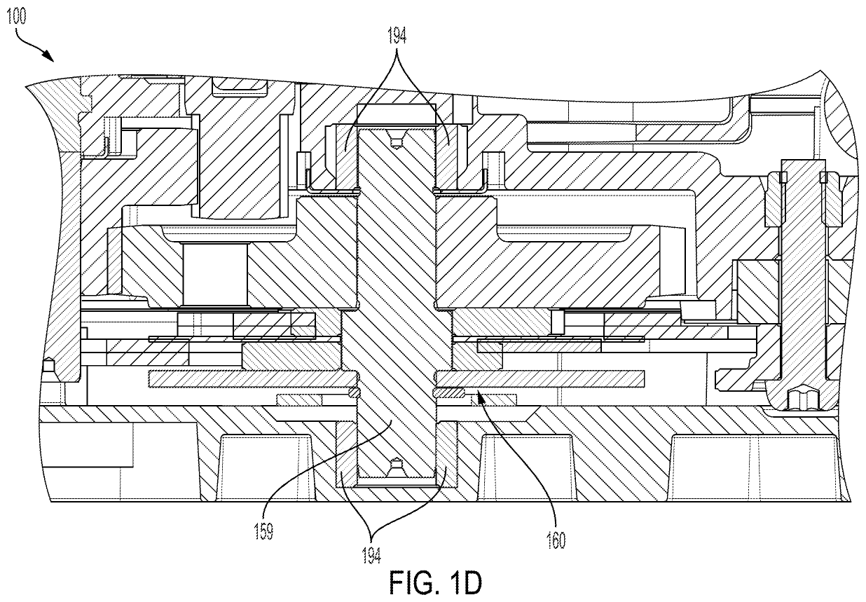

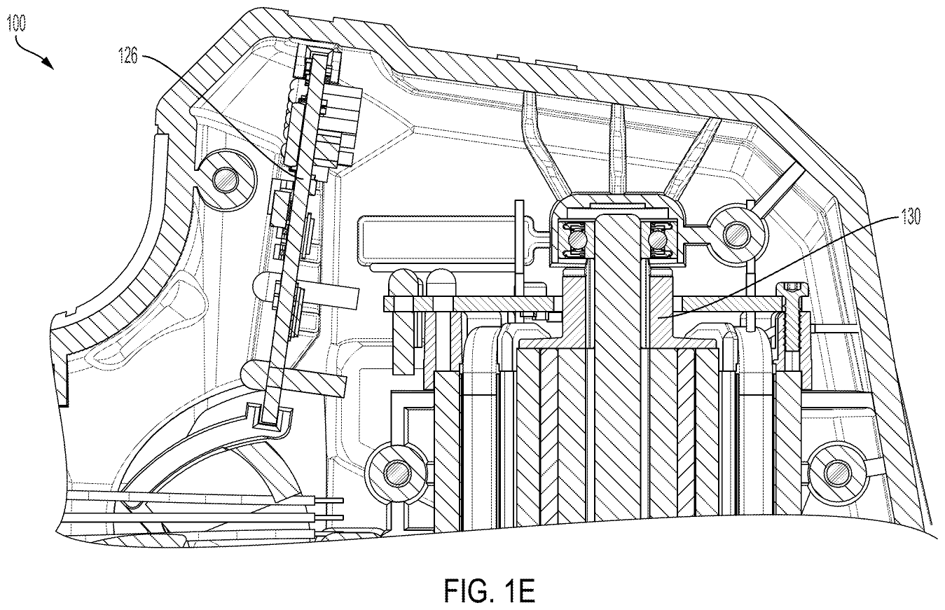

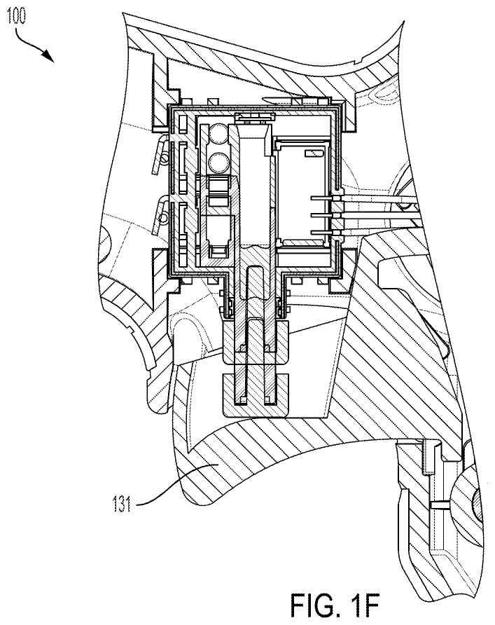

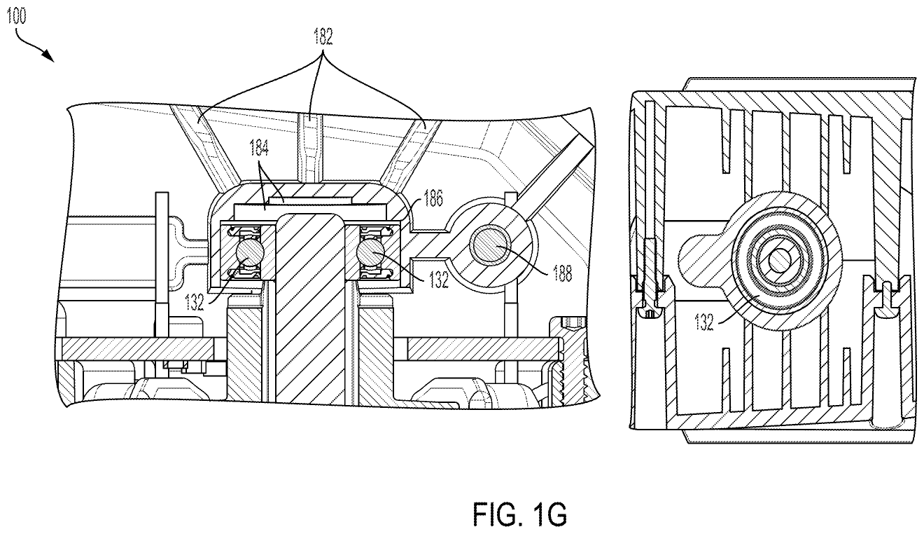

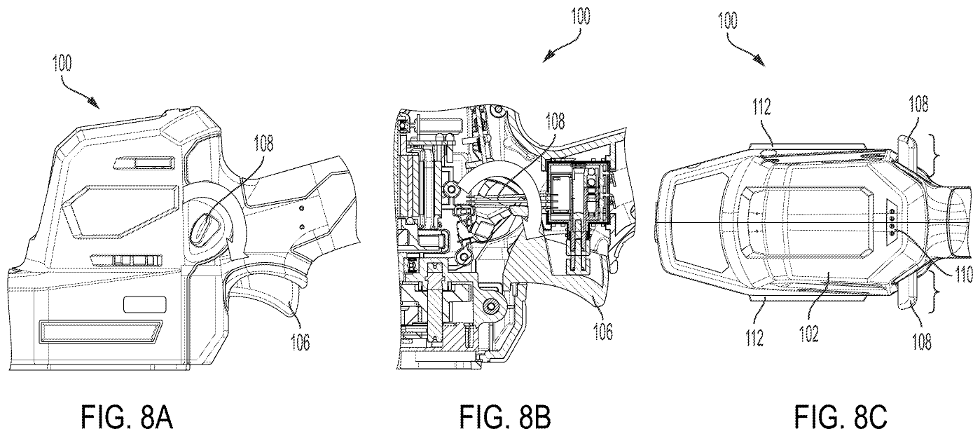

FIG. 1A depicts an embodiment of an outdoor tool 100, such as a hedge trimmer, for use in performing outdoor tasks such as trimming hedges. As depicted, in some embodiment, the outdoor tool 100 includes a housing 102 and a blade assembly 140 for performing trimming. As depicted, in some embodiments, the housing 102 includes a handle portion 104 that allows a user to control the outdoor tool 100 and engage power to the tool through a trigger 106. As depicted, in some embodiments, the outdoor tool 100 includes a butterfly switch 108 on each side of the housing 102 that can be engage to lockout the trigger 106. As depicted, in some embodiments, the outdoor tool 100 includes an overmold bumper 112 (see FIG. 8C) on each side of the housing 102 to prevent marring. In some embodiments, the housing 102 include a fuel gauge 110 (see FIG. 8C) or battery indictor located on the top of the tool for indicating a charge status of the battery pack. In some embodiments, the outdoor tool 100 is an 8″ hedge trimmer.

FIG. 1B depicts a side sectional, perspective view of an embodiment of the outdoor tool 100. The depicted components include a battery pack 120, a switch 122, the trigger 106, a lockout paddle 124, a Printed Circuit Boards Assembly (“PCBA”) 126, a motor (e.g., a brushless direct current [“BLDC”) motor) 130, a gear case 150, and a gear case cover 152. In the depicted construction, various components of the blade assembly 140 are also depicted including a blade mounting washer 142, a blade spine 144, a blade tip guard 146, and two reciprocating blades 147 and 148. The motor 130 generates a motive force to drive the blade assembly 140 during operation of the outdoor tool 100. In the illustrated construction, each blade 147 and 148 is reciprocatable relative to the housing 102.

In some embodiments, the motor 130 is configured to be operated in either a forward rotational direction or a reverse rotational direction. In some embodiments, the outdoor tool 100 is configured to alternate between a forward rotational direction and a reverse rotational direction based on the cycling of the trigger 106. For example, when a user activates the trigger 106 a first time, the outdoor tool 100 is configured to operate the motor 130 in the forward rotational direction. When the user deactivates (e.g., releases) and then re-activates or cycles the trigger 106, the outdoor tool 100 is configured to then operate the motor 130 in the reverse rotational direction. In some embodiments, the rotational direction of the motor 130 switches between the forward rotational direction and the reverse rotational direction with each cycling of the trigger 106.

In some embodiments, the outdoor tool 100 is battery pack powered. In some embodiments, the motor 130 is a single speed motor. In some embodiments, the motor 130 rotates is one direction only. In some embodiments, the motor 130 is a BLDC motor. In some embodiments, the trigger 106 is a dual action trigger. In some embodiments, the outdoor tool 100 includes two stage spur gears and a Scotch Yoke style mechanism. As depicted, in some embodiments, the battery pack 120 is isolated from the motor 130 in the handle portion 104 supplies power to the motor 130. In some embodiments, the motor is mounted within a handle portion 104 of the housing.

In some embodiments, the blades 147, 148 have a first plane or axis 114 about which they operate. The first plane 114 is approximately parallel to a second plane or axis 116 that is formed by the battery pack 120 (e.g., a central axis of insertion of the battery pack 120. Additionally, a third plane or axis 118 of the handle forms acute angles with both the first plane 114 and the second plane 116 to provide a physical offset between the first plane 114 and the second plane 116 through the handle. In some embodiments, the first plane 114 and the second plane 116 are approximately perpendicular to a central axis 119 of the motor 130. In some embodiments, the orientation of the outdoor tool 100 includes a center-of-gravity (“COG”) 121 that sits directly above the trigger 106 (and a user's grip) such that the outdoor tool is balanced between the battery pack 120 end of the outdoor tool 100 and the blade 147, 148 side of the outdoor tool 100.

FIG. 1C depicts another side sectional, perspective view of an embodiment of the outdoor tool 100. The depicted components include components of the motor 130 including a rear rotor bearing 132, a pinion 134, and a front bearing 136. The depicted components include components of a gear assembly including a middle gear 154, wear washers 156, and an output gear 158, an output shaft 159, and a cam assembly (or cam stack) 160, which transfers the motive force provided by the motor 130 the blade assembly 140 (see FIG. 1A). In some embodiments, the mounting geometry around the gear assembly provides a tight fit to align the bearings 132 and 136. The depicted components also include blade mounting screws 190 and a foam block 192, which secure the blade assembly 140 to the housing 102.

FIG. 1D depicts an embodiment of the outdoor tool 100 with additional support structures 194 (e.g., insert molded bushings for the gearbox and cover) on the housing 102 for the output shaft 159, rather than, for example, a single-sided cantilevered support. In some embodiments, these support structures 194 prevent wear on the gear case 150 and provide support for the reciprocating blades 147 and 148 (see FIG. 1B) and the cam assembly 160.

FIG. 1E depicts an embodiment of the outdoor tool 100 illustrating an orientation of the PCBA 126 relative to the motor 130. The depicted embodiment has an acute inner angle (e.g., approximately 82 degrees) between the PCBA 126 and the motor 130 and motor position sensing PCB. The angle of the PCBA 126 relative to the motor allows for a more compact design of the outdoor tool 100.

FIG. 1F depicts an embodiment of the outdoor tool 100 illustrating a type of the trigger switch 131.

FIG. 1G depicts an embodiment of a bearing pocket geometry of the outdoor tool 100. As depicted, the bearing pocket geometry includes ribs 182 that provide additional support, clearance 184 to account for rotor shaft tolerances, steps 186 that provide contact with an outer race only, and a single screw boss 188 for handle clamping.

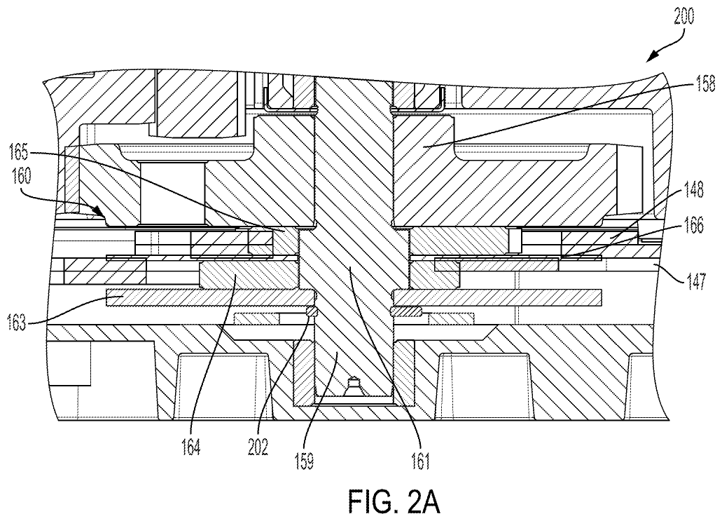

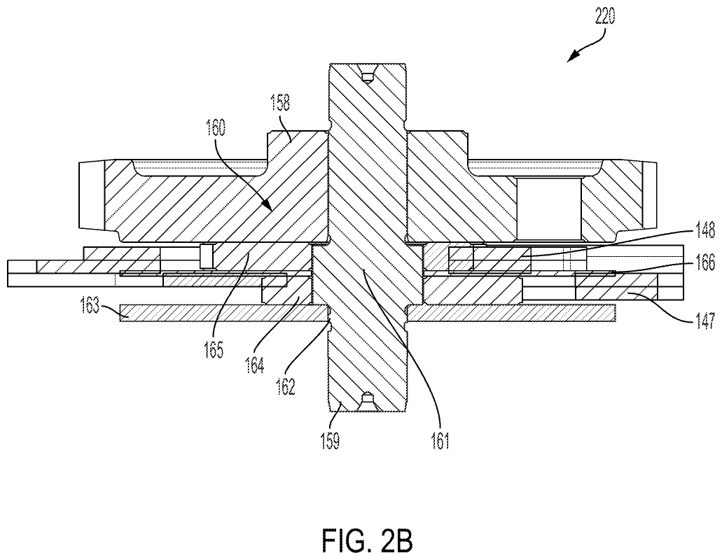

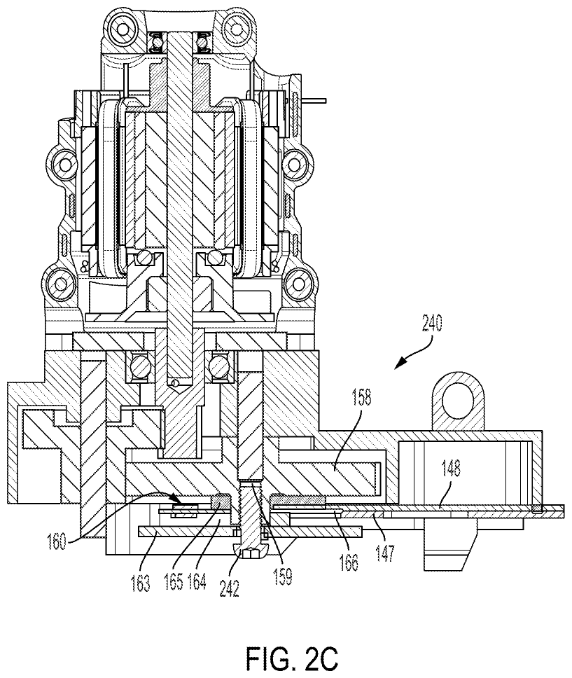

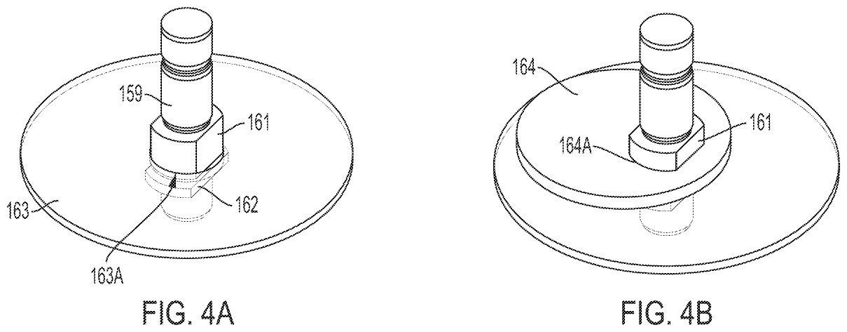

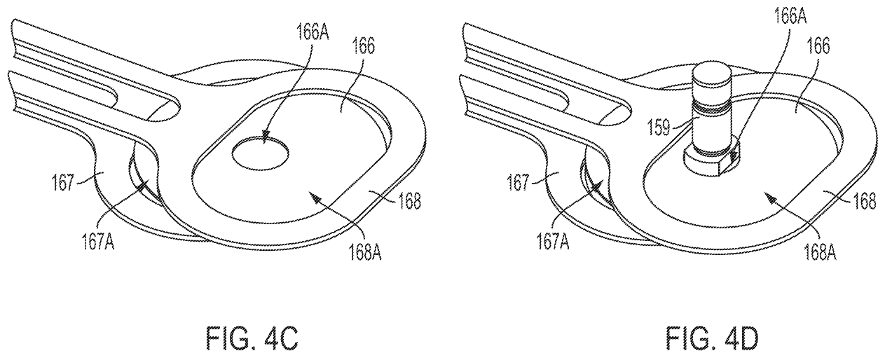

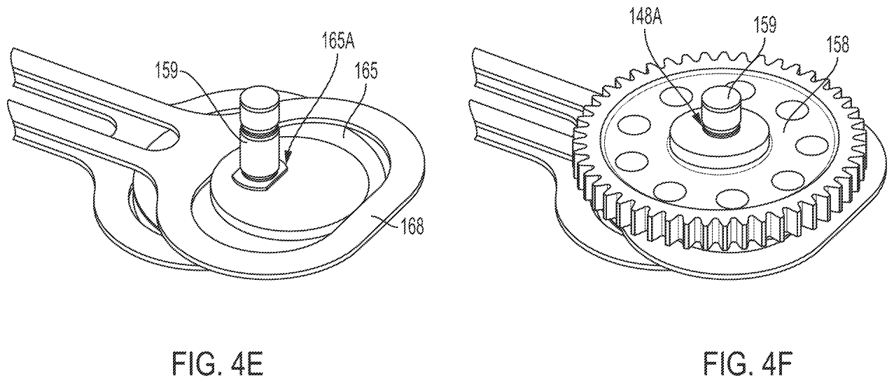

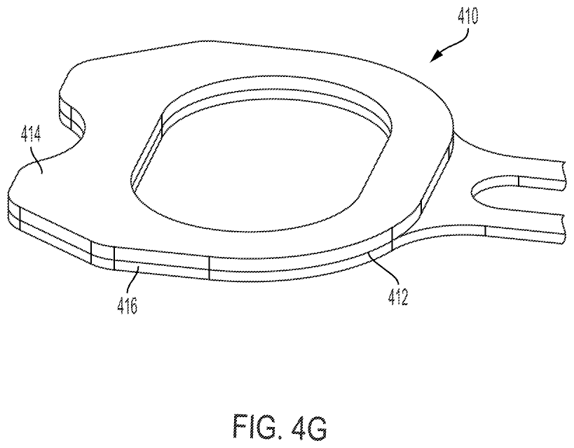

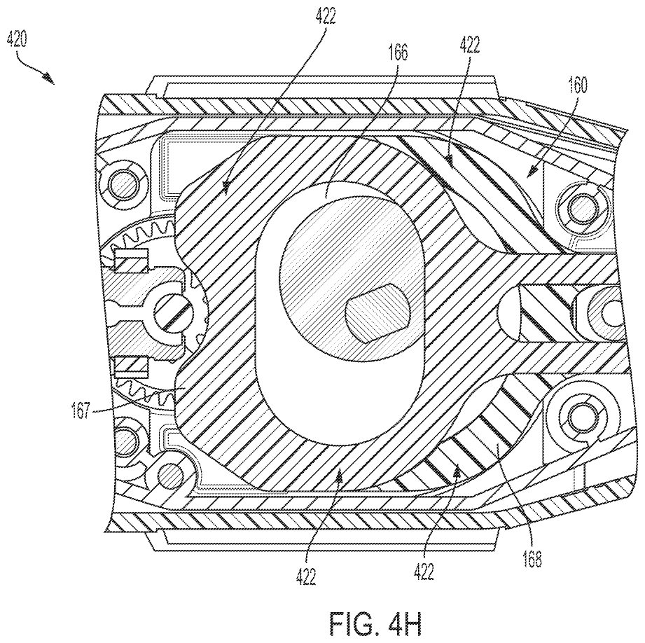

FIGS. 2A, 2B, and 2C depict a side section view of embodiments of the cam assembly 160. In the depicted constructions 200, 220, and 240, the cam assembly 160 includes a cam cover 163, a first cam coin 164 and second cam coin 165. In the depicted constructions 200 and 220, the proximal end (respective to the housing 102) of each of the reciprocating blades 147 and 148 (see proximal ends 167 and 168, respectively, in FIG. 4C) are secured to the output shaft 159 via the cam coins 164 and 165 and are separated by, for example, a separation washer 166.

In the depicted construction 200 of FIG. 2A, a retaining ring 202 is employed to support the cam assembly 160. In the depicted construction 220 in FIG. 2B, a shoulder portion 162 of the output shaft 159 (referenced herein as the shoulder or second portion) is enlarged to support the cam assembly 160. In the depicted construction 240 of FIG. 2C, a threaded bolt 242 is employed to support the cam assembly 160 in a non-permanent (e.g., removable) manner.

The constructions 200 and 220 also include a wider profile portion 161 of the output shaft 159 (referenced herein as a profile or first portion), which extends along the profiles of the components of the cam assembly 160. The profile portion 161 depicted in the construction 200 does not extend along the profile of the cam cover 163, while the profile portion 161 depicted in the construction 220 does extend along the profile of the cam cover 163. Also, the cam cover 163 depicted in the construction 220 is increased to fit over or extend past the profile portion 161. In both depicted constructions 200 and 220, the output gear 158 is supported by the cam assembly 160 and integrated on the output shaft 159 for torque transmission.

The depicted constructions 200, 220, and 240 allow for the cam assembly 160 to be pressed securely to the output shaft 159 and remove the clearance between cam cover 163, the cam coins 164 and 165, and the separation washer 166. The depicted constructions 200 and 220 also allow for a higher minimum holding force (e.g., 750 pound-force [lbf]). Additionally, trapping the separation washer 166 between the cam coins 164 and 165 prevents the reciprocating blades 147 and 148 from skipping out of cam interfaces (e.g., the profile portion 161).

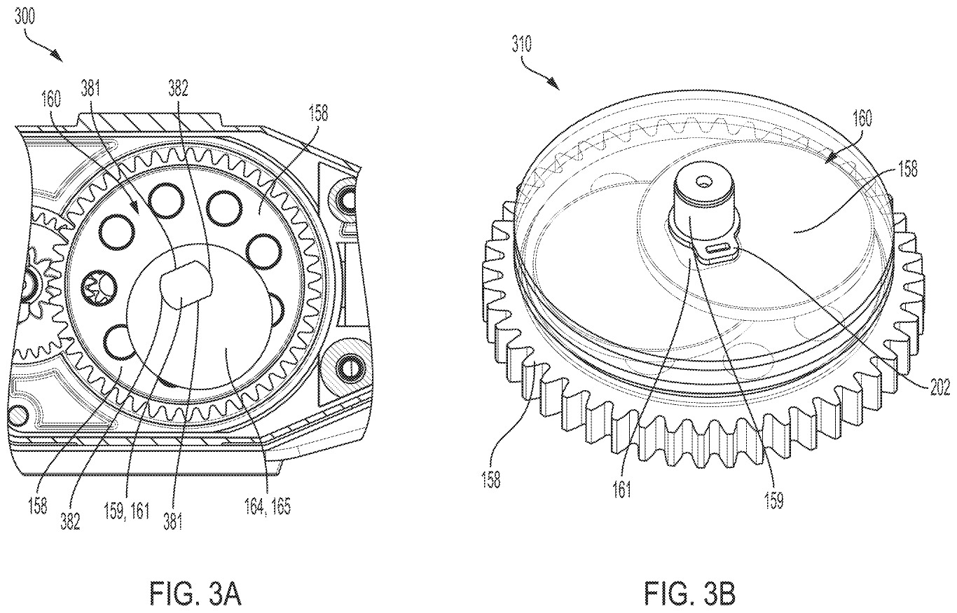

FIG. 3A depicts a cross sectional view 300 of an embodiment of the cam assembly 160 and the output shaft 159. In the depicted construction, the shape of the profile portion 161 includes two substantially flat portions 381 and two curved portions 382 (e.g., a D-shaped profile). In some embodiments, the shape of the profile portion 161 allows the cam assembly and specifically the first and second cam coins 164 and 165 to be secured to the output shaft 159.

FIG. 3B depicts a bottom perspective view of a construction 310 of an embodiment of the cam assembly 160, where the output gear 158 is secured to the output shaft 159 and the first and second cam coins 164 and 165 are positioned 180 degrees apart or offset, and are secured to the profile portion 161 to provide for the opposing motion of the reciprocating blades 147 and 148 (see FIG. 1A). The depicted construction 310 also includes the retaining ring 202 as depicted in FIG. 2A, however, the shoulder portion 162 (not shown) could be employed in other embodiments. In some embodiments, the output gear 158 is welded to the output shaft 159.

FIGS. 4A-4F depict an example assembly process for the cam assembly 160. FIG. 4A depicts the profile portion 161 and shoulder portion 162 of the output shaft 159. In some embodiments, the cam cover 163 is positioned adjacent to the shoulder portion 162 and secured via an opening 163a that is shaped to fit securely around the profile portion 161.

FIG. 4B depicts the addition of the first cam coin 164. In some embodiments, the first cam coin 164 is positioned adjacent to the cam cover 163 and is secured via an opening 164A that is shaped to fit securely around the profile portion 161.

FIG. 4C depicts the separation washer 166 positioned between the proximal ends 167 and 168 of the reciprocating blades 147 and 148. As depicted, the separation washer 166 has an opening 166A and each of the proximal ends 167 and 168 has a respective opening 167A and 168A. FIG. 4D depicts the separation washer 166 and the proximal ends 167 and 168 of the reciprocating blades 147 and 148 positioned on the output shaft 159 via their respective openings 166A, 167A, and 168A.

FIG. 4E depicts the addition of the second cam coin 165, which is positioned adjacent to the proximal end 168 of the reciprocating blade 148 and secured via an opening 165a that is shaped to fit securely around the profile portion 161. As depicted, the two cam coins 164 and 165 secure the reciprocating blades 147 and 148 to the output shaft 159.

FIG. 4F depicts the addition of the output gear 158. The output gear 158 is positioned adjacent to the second cam coin 165 and secured via an opening 148A that is shaped to fit securely around the output shaft 159, which integrates the output gear 158 on the output shaft 159 for torque transmission.

FIG. 4G depicts an embodiment 410 of the proximal ends 167 and 168 of the reciprocating blades 147 and 148. As depicted, the proximal end 410 includes a double stacked hoop 412. In some embodiments, the double stacked hoop 412 is formed by welding the top portion 414 to the bottom portion 416. In some embodiments, the double stacked hoop 412 reduces axial clearances in the cam assembly 160, limits twisting of the reciprocating blades 147 and 148, and provides additional contact surface to reduce wear.

FIG. 4H depicts an embodiment 420 of the cam assembly 160. As depicted, the proximal ends 167 and 168 of the reciprocating blades 147 and 148 include two “ear” portions 422 that extend beyond the cam assembly 160. As depicted, the ear portions 422 increase the surface of the respective proximal ends 167 and 168 to support the respective reciprocating blades 147 and 148 more fully and prevent the respective openings 167A and 168A from actuating the washer 166 as a leaf spring.

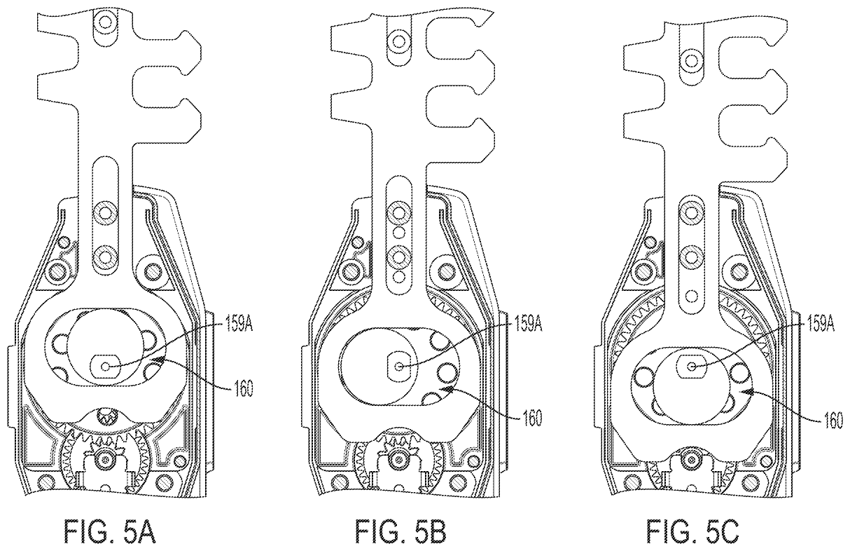

FIGS. 5A-5C depict an embodiment of the outdoor tool 100 in which the cam assembly 160 is supported for rotation about an axis to rotate eccentrically with respect to the output shaft axis 159A.

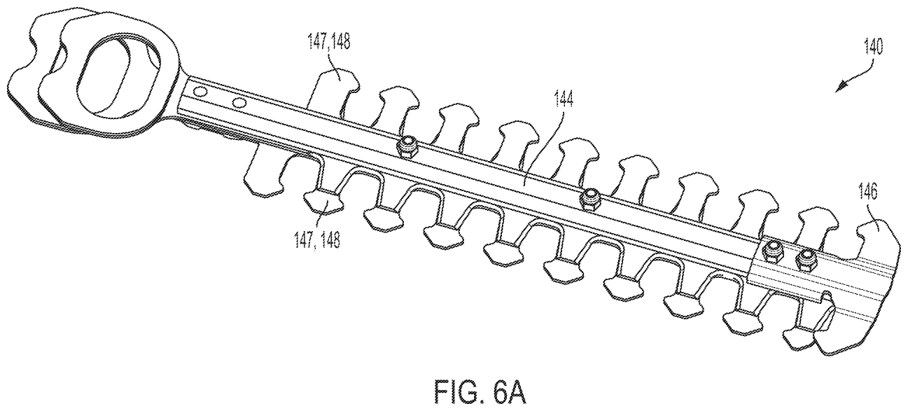

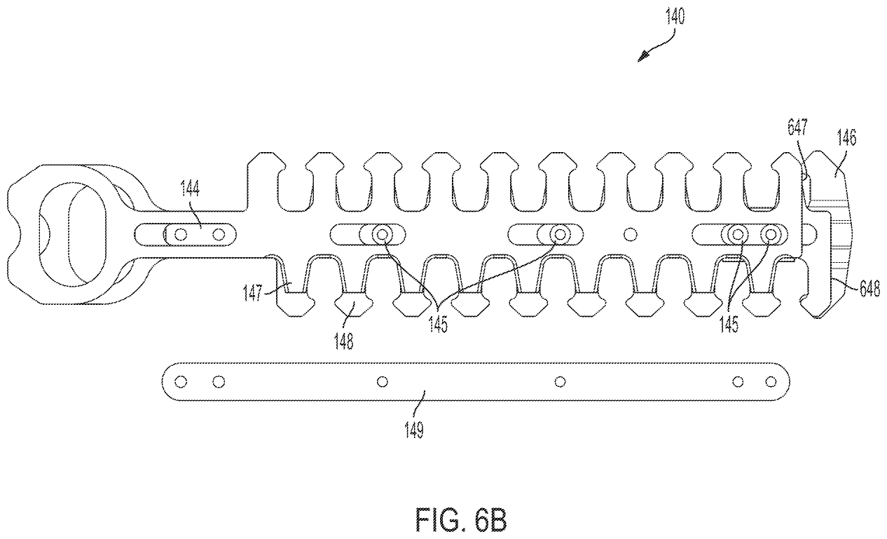

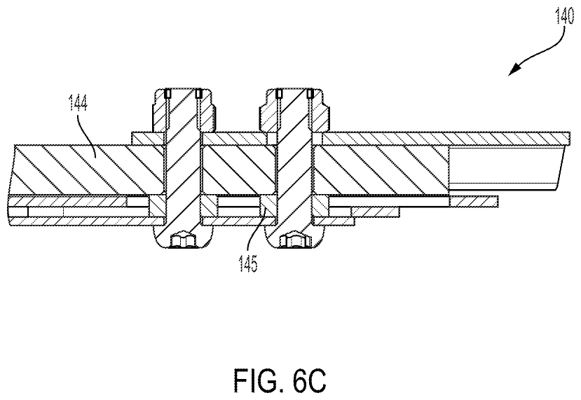

FIGS. 6A-6C depict an embodiment of the blade assembly 140. FIG. 6A depicts the two reciprocating blades 147 and 148, which are secured to the blade spine 144 and covered with the blade tip guard 146. FIG. 6B depicts the reciprocating blades 147 and 148 sandwiched between the blade spine 144 and a blade cover 149. As depicted, the blades 147 and 148 include various slots with bushings 145 to keep the blades aligned while reciprocating. FIG. 6C depicts the bushings 145 clamped between the blade spine 144 and the blade cover 149. In some embodiments, the bushings 145 are stationary with respect to blade spine 144, control the gap between the reciprocating blades 147 and 148, or allow for the reciprocating motion between the blades. In some embodiments, the blade spine 144 is made from aluminum (e.g., rather than stamped, folded sheet steel) to reduce weight and improve overall performance of the outdoor tool 100. As depicted, in some embodiments, each of the reciprocating blades distal ends 647 and 648 of the respective reciprocating blades 147 and 148 is blunt.

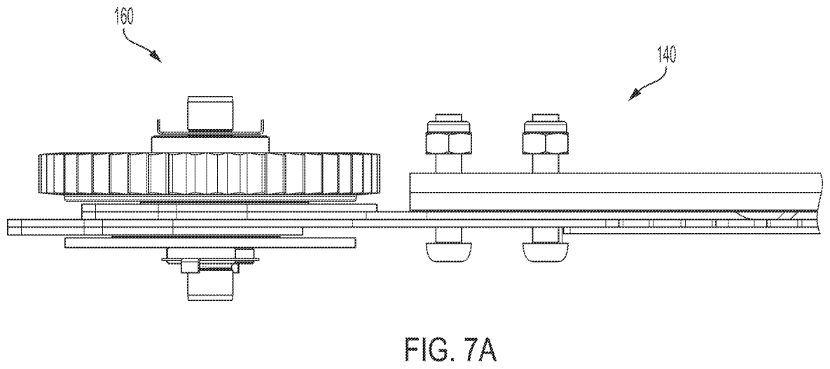

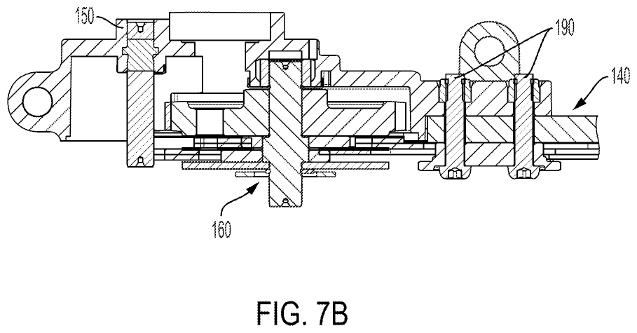

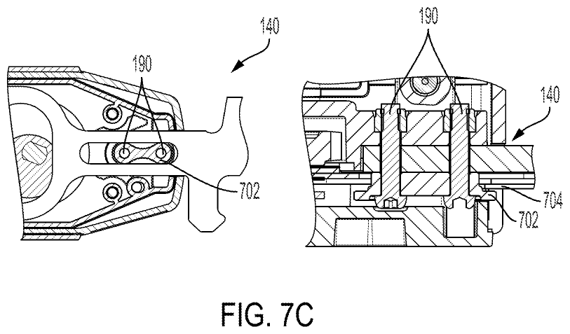

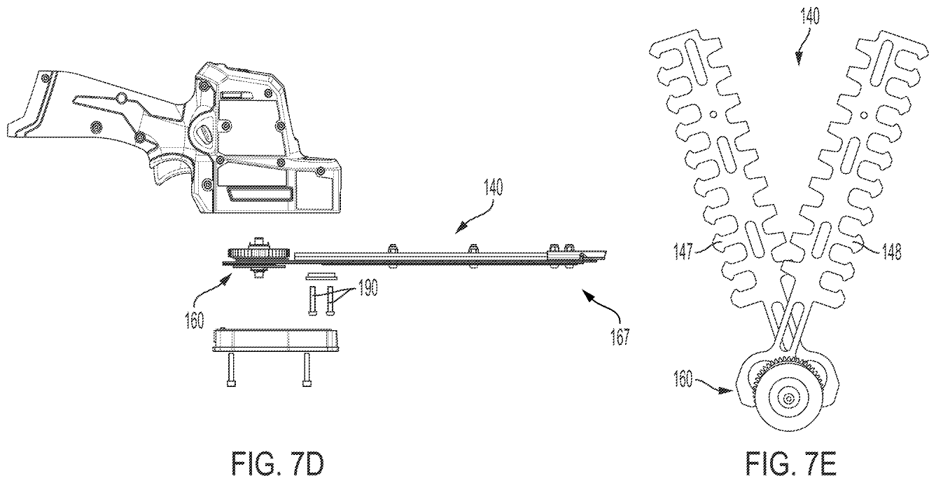

FIG. 7A depicts an embodiment of the cam assembly 160 assembled onto the blade assembly 140.

FIG. 7B depicts embodiments of the blade assembly 140 and the cam assembly 160 secured to the gear case 150 via the blade mounting screws 190. In some embodiments, each of the blade mounting screws 190 are secured to the gear case 150 with a fastener (e.g., a hexagonal nut). In some embodiments, the reciprocating blades 147 and 148 are rigidly mounted to the gear case 150 to allows for a tighter tolerance stack and to prevent blade disengagement, more robust against drops, or less vibration.

FIG. 7C depicts embodiments of the blade assembly 140 that includes a peanut shaped bushing 702 that provides two contact surfaces in one bushing. The peanut shaped bushing 702 has an increased length that conventional blade bushings at the gearbox mounting. The bushing 702 also includes an increased size for a step 704 to allow the blades to flex during both assembly and operation. Additionally, because the bushing includes two contact surfaces, fewer parts are required for assembly.

FIGS. 7D and 7E depict an embodiment of the blade assembly 140 and the cam assembly 160 illustrating a fanned positioning of the reciprocating blades 147 and 148. When fanned, the reciprocating blades 147 and 148 can be, for example, sharpened individually. As depicted, in some embodiments, the cam assembly 160 remains intact and the reciprocating blades 147 and 148 are not removed from the outdoor tool 100 or the output gear 158 when fanned.

FIGS. 8A-8C depict an embodiment of the outdoor tool 100 illustrating an engagement of the butterfly switch 108. FIGS. 8A and 8B illustrate an embodiment of how the butterfly switch 108 is engaged to lock the trigger 106 (i.e., prevent the trigger 106 from being depressed). FIG. 8C depicts an embodiment illustrating the butterfly switch 108 in relation to the housing 102. In embodiment depicted in FIG. 8C, the butterfly switch 108 extends on each side of the housing 102 beyond the outer side surfaces of the housing (e.g., such that the butterfly switch 108 is clear from and accessible by a user without interference from the housing 102).

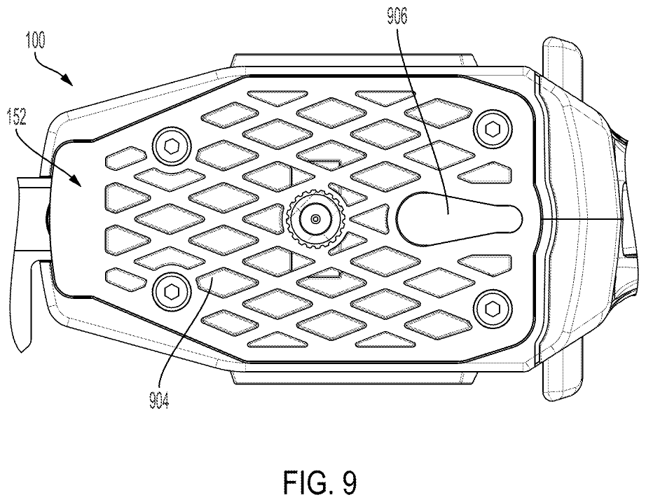

FIG. 9 depicts an embodiment of the gear case cover 152. As depicted, in some embodiments, gear case cover 152 is formed with a material reduction pattern 904 and includes an integrated hand hook feature 904 for hanging the outdoor tool 100 when stored. In some embodiments, the gear case 150 is made from die-cast metal to improve strength.

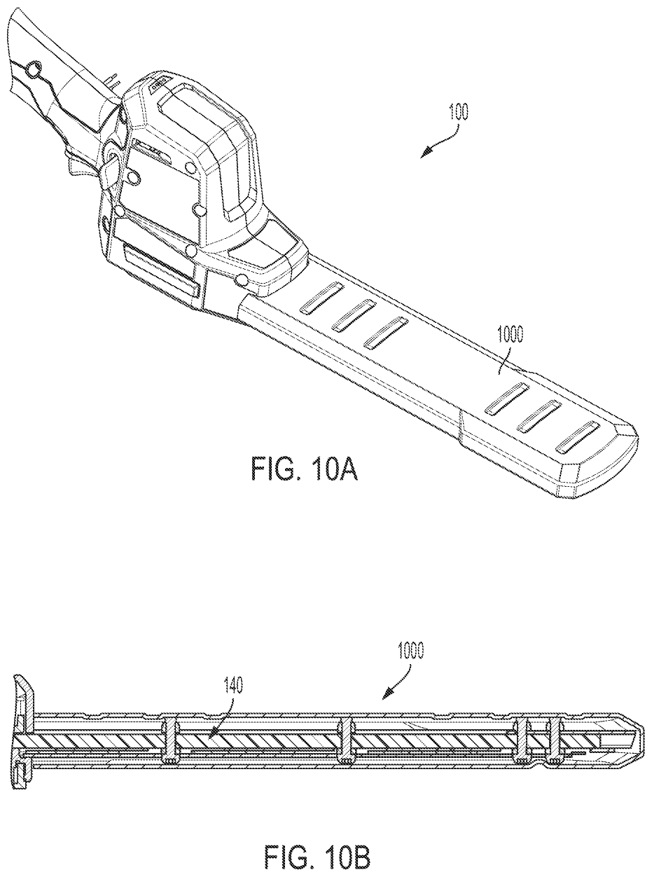

FIGS. 10A-10B depict an embodiment of the outdoor tool 100 that includes a blade sheath 1000. As depicted, in some embodiments, the blade sheath 1000 is fully enclosed to protect the blades 147, 148.

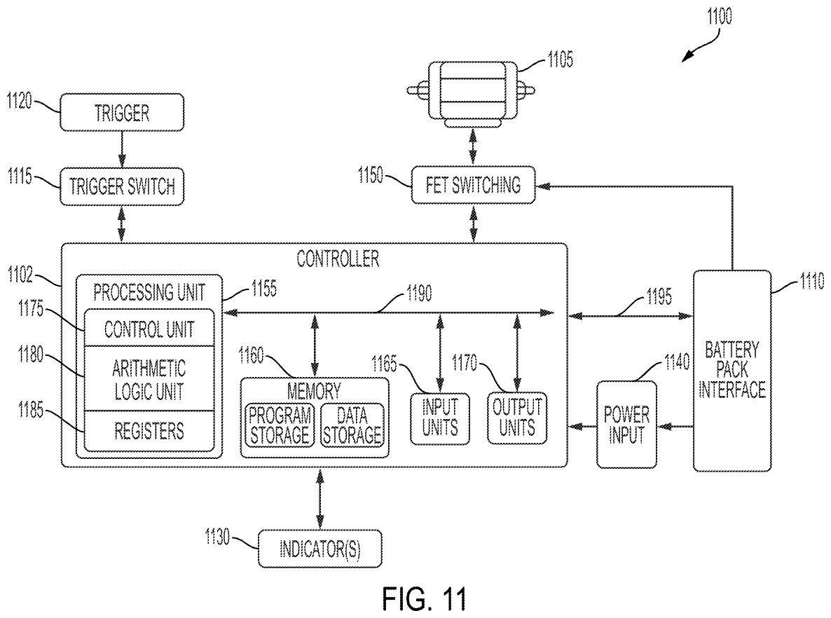

FIG. 11 depicts a control system 1100 for the outdoor tool 100. The control system 1100 includes a controller 1102. The controller 1102 is electrically or communicatively connected to a variety of modules or components of the outdoor tool 100. For example, the illustrated controller 1102 is electrically connected to a motor 1105 (e.g., motor 130), a battery pack interface 1110, a trigger switch 1115 (connected to a trigger 1120), one or more indicators 1130, a power input module 1140, and a FET switching module 1150 (e.g., including a plurality of switching FETs). The controller 1102 includes combinations of hardware and software that are operable to, among other things, control the operation of the outdoor tool 100, monitor the operation of the outdoor tool 100, activate the one or more indicators 1130 (e.g., an LED), etc. For example, the controller can be configured to receive an input signal from the trigger 1120 and alternate the rotational direction of the motor 1105 based on the received input. In some embodiments, a next direction or a previous direction of the motor is stored in a counter or as a binary value (e.g., a “0” or a “1” corresponding to an input pin of the controller 1102).

The controller 1102 includes a plurality of electrical and electronic components that provide power, operational control, and protection to the components and modules within the controller 1102 or the outdoor tool 100. For example, the controller 1102 includes, among other things, a processing unit 1155 (e.g., a microprocessor, a microcontroller, an electronic processor, and electronic controller, or another suitable programmable device), a memory 1160, input units 1165, and output units 1170. The processing unit 1155 includes, among other things, a control unit 1175, an arithmetic logic unit (“ALU) 1180, and a plurality of registers 1185 (shown as a group of registers in FIG. 11) and is implemented using a known computer architecture (e.g., a modified Harvard architecture, a von Neumann architecture, etc.). The processing unit 1155, the memory 1160, the input units 1165, and the output units 1170, as well as the various modules or circuits connected to the controller 1102 are connected by one or more control or data buses (e.g., common bus 1190). The control or data buses are shown generally in FIG. 11 for illustrative purposes. The use of one or more control or data buses for the interconnection between and communication among the various modules, circuits, and components would be known to a person skilled in the art in view of the disclosure described herein.

The memory 1160 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 1155 is connected to the memory 1160 and executes software instructions that are capable of being stored in a RAM of the memory 1160 (e.g., during execution), a ROM of the memory 1160 (e.g., on a generally permanent basis), or another non-transitory computer readable medium such as another memory or a disc. Software included in the implementation of the outdoor tool 100 can be stored in the memory 1160 of the controller 1102. The software includes, for example, firmware, one or more applications, program data, filters, rules, one or more program modules, and other executable instructions. The controller 1102 is configured to retrieve from the memory 1160 and execute, among other things, instructions related to the control processes and methods described herein. In other constructions, the controller 1102 includes additional, fewer, or different components.

The battery pack interface 1110 includes a combination of mechanical components (e.g., rails, grooves, latches, etc.) and electrical components (e.g., one or more terminals) configured to and operable for interfacing (e.g., mechanically, electrically, and communicatively connecting) the outdoor tool 100 with a battery pack. For example, power provided by the battery pack to the outdoor tool 100 is provided through the battery pack interface 1110 to the power input module 1140. The power input module 1140 includes combinations of active and passive components to regulate or control the power received from the battery pack prior to power being provided to the controller 1102. The battery pack interface 1110 also supplies power to the FET switching module 1150 to be switched by the switching FETs to selectively provide power to the motor 1105. The battery pack interface 1110 also includes, for example, a communication line 1195 for providing a communication line or link between the controller 1102 and the battery pack.

The indicators 1130 include, for example, one or more light-emitting diodes (“LEDs”). The indicators 1130 can be configured to display conditions of, or information associated with, the outdoor tool 100. For example, the indicators 1130 are configured to indicate measured electrical characteristics of the outdoor tool 100, the status of the outdoor tool 100, etc.

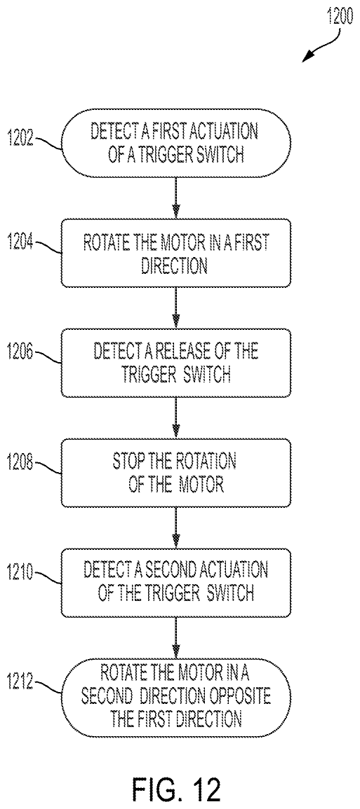

FIG. 12 depicts a flow diagram of an example process 1200 for operating a hedge trimmer, such as the outdoor tool 100, that can be executed by, for example, the controller 1102. For clarity of presentation, the description that follows generally describes the process 1200 in the context of FIGS. 1-11. For example, the outdoor tool 100 includes a trigger switch, such as the trigger 106, and a motor, such as motor 130. However, it will be understood that the process 1200 may be performed, for example, by any other suitable system or a combination of systems as appropriate.

At STEP 1202, a first actuation of the trigger 106 is detected. From STEP 1202, the process 1200 proceeds to STEP 1204.

At STEP 1204, the motor is rotated in a first direction. From STEP 1204, the process 1200 proceeds to STEP 1206.

At STEP 1206, a release of the trigger 106 is detected. From STEP 1206, the process 1200 proceeds to STEP 1208.

At STEP 1208, the rotation of the motor is stopped. From STEP 1208, the process 1200 proceeds to STEP 1210.

At STEP 1210, a second actuation of the trigger switch is detected. From STEP 1210, the process 1200 proceeds to STEP 1212.

At STEP 1212, the motor 130 is rotated in a second direction opposite the first direction. In some embodiments, a next direction or a previous direction of the motor 130 is stored in a counter or as a binary value (e.g., a “0” or a “1” corresponding to a voltage of an input pin of the controller 802). In some embodiments, the direction of the motor 130 is determined based on the stored direction. Following STEP 1212, the process 1200 is continually executed such that the direction of rotation of the motor alternately switches between the first direction and the second direction with each trigger pull and release. In some embodiments, the direction of rotation of the motor is only switched to the opposite direction after two or more consecutive trigger pulls and releases where the motor was operated in the same direction. In some embodiments, the motor 130 is rotated in the first direction for at least two consecutive trigger pulls and releases, and then operated in the second opposite direction for only one trigger pull and release. As a result, the motor is operated in the first direction more than it is operated in the second opposite direction.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Moreover, the separation or integration of various system modules and components in the implementations described earlier should not be understood as requiring such separation or integration in all implementations, and it should be understood that the described components and systems can generally be integrated together in a single product or packaged into multiple products. Accordingly, the earlier description of example embodiments does not define or constrain this disclosure. Other changes, substitutions, and alterations are also possible without departing from the spirit and scope of this disclosure.

Thus, embodiments described herein provide an outdoor tool, such as a hedge trimmer, comprising an output shaft that is positioned through respective aligned openings such that the formed cam assembly is positioned at a perpendicular plane respective to the second portion and supported for rotation about an axis to rotate eccentrically with respect to the output shaft axis. Various features and advantages are set forth in the following claims.

### Example Configurations

Various aspects of the present disclosure may take any one or more of the following example configurations:

EEE(1) A hedge trimmer comprising: a first blade including a first blade opening at a first proximal end; a second blade including a second blade opening at a second proximal end; a first cam coin including a first cam coin opening; a second cam coin including a second cam coin opening; an output gear including an output gear opening; and an output shaft including a first portion and a second portion, the first portion being wider than the first cam coin opening and the second cam coin opening, the second portion being wider than the output gear opening, wherein the first cam coin opening and the second cam coin opening are aligned to form a cam assembly, wherein the output shaft is positioned through the first cam coin opening and the second cam coin opening, and wherein the cam assembly is positioned in a perpendicular plane with respect to the second portion and is supported for rotation about an axis to rotate eccentrically with respect to the output shaft axis.

EEE(2) The hedge trimmer according to EEE(1), wherein the output shaft is positioned such that the first portion supports the cam assembly and the second portion supports the output gear.

EEE(3) The hedge trimmer according to any one of EEE(1) or EEE(2), wherein the first cam coin and the second cam coin are positioned 180 degrees apart respective to the output shaft.

EEE(4) The hedge trimmer according to any one of EEE(1) to EEE(3), further comprising: a cam cover including a cover opening; and a slide cam washer including a slide cam opening, wherein: the cover opening and the slide cam opening are aligned with the first cam coin opening and the second cam coin opening to form the cam assembly, the output shaft is positioned through the slide cam opening, the cam cover is adjacent to a surface of the first portion, the first cam coin is adjacent to the cam cover, the first proximal end of the first blade is adjacent to the first cam coin, the slide cam washer is adjacent to the first proximal end of the first blade, the second proximal end of the second blade is adjacent to the slide cam washer, the second cam coin is adjacent to the second proximal end of the second blade, and the output gear is adjacent to the second cam coin.

EEE(5) The hedge trimmer according to any one of EEE(1) to EEE(4), wherein the cam assembly is configured to rigidly mount the first blade and the second blade to prevent disengagement of the first blade and the second blade.

EEE(6) The hedge trimmer according to any one of EEE(1) to EEE(5), further comprising: a motor coupled to the output gear, wherein the output gear is configured to transmit forces generated by the motor to rotate the output shaft.

EEE(7) The hedge trimmer according to any one of EEE(1) to EEE(6), comprising: a housing; and a battery pack configured to supply power to the motor.

EEE(8) The hedge trimmer according to any one of EEE(1) to EEE(7), wherein the motor is mounted within the housing.

EEE(9) The hedge trimmer according to any one of EEE(1) to EEE(8), wherein the motor is a brushless direct current motor.

EEE(10) The hedge trimmer according to any one of EEE(1) to EEE(9), wherein: the motor is configured to operate in a forward rotational direction or a reverse rotational direction; and the motor is configured to alternate between the forward rotational direction and the reverse rotational direction based on an input signal.

EEE(11) The hedge trimmer according to any one of EEE(1) to EEE(10), further comprising: a trigger switch configured to generate the input signal.

EEE(12) The hedge trimmer according to any one of EEE(1) to EEE(11), further comprising: a butterfly switch configured to lock the trigger switch.

EEE(13) The hedge trimmer according to any one of EEE(1) to EEE(12), wherein the input signal includes a voltage.

EEE(14) The hedge trimmer according to any one of EEE(1) to EEE(13), further comprising: a controller connected to the motor and including: one or more processors; and a non-transitory computer readable medium connected to the one or more processors and having instructions stored thereon which, when executed by the one or more processors, cause the one or more processors to: receive the input signal, and alternate a rotational direction of the motor based on the input signal.

EEE(15) The hedge trimmer according to any one of EEE(1) to EEE(14), wherein the first blade and the second blade are at least eight-inch blades.

EEE(16) The hedge trimmer according to any one of EEE(1) to EEE(15), further comprising: a gear case, wherein the cam assembly is coupled to the gear case.

EEE(17) The hedge trimmer according to any one of EEE(1) to EEE(16), further comprising: a gear case cover coupled to the gear case, wherein the gear case cover is formed with a material reduction pattern and includes an integrated hand hook feature.

EEE(18) The hedge trimmer according to any one of EEE(1) to EEE(17), further comprising: a blade assembly coupled to the cam assembly, the blade assembly including the first blade, the second blade, a blade spine, and a plurality of bushings, wherein: the first blade and the second blade are affixed to the blade spine, and the plurality of bushings are stationary with respect to the blade spine and allow for reciprocating motion between the first blade and the second blade.

EEE(19) The hedge trimmer according to any one of EEE(1) to EEE(18), wherein the blade assembly is secured to the gear case via a plurality of blade mounting screws.

EEE(20) The hedge trimmer according to any one of EEE(1) to EEE(19), wherein the blade assembly that includes a peanut-shaped bushing.

EEE(21) The hedge trimmer according to any one of EEE(1) to EEE(20), wherein each of the blade mounting screws are secured to the gear case via a respective fastener.

EEE(22) The hedge trimmer according to any one of EEE(1) to EEE(21), wherein each of the fasteners include a hexagonal nut.

EEE(23) The hedge trimmer according to any one of EEE(1) to EEE(22), wherein the first proximal end of the first blade and the second proximal end of the second blade each include two stacked layers and an ear portion that extends beyond the cam assembly.

EEE(24) The hedge trimmer according to any one of EEE(1) to EEE(23), wherein the first blade and the second blade are configurable to a fanned position.

EEE(25) The hedge trimmer according to any one of EEE(1) to EEE(24), wherein the cam assembly is configured to remain intact when the first blade and the second blade are in the fanned position.

EEE(26) The hedge trimmer according to any one of EEE(1) to EEE(25), further comprising: a fully-enclosed blade sheath to protect the first blade and the second blade.

EEE(27) A method of operating a hedge trimmer, the hedge trimmer including a trigger switch and a motor, the method comprising: detecting, by a controller, a first actuation of the trigger switch; rotating, by the controller, the motor in a first direction; detecting, by the controller, a release of the trigger switch; stopping the rotation of the motor; detecting, by the controller, a second actuation of the trigger switch; and rotating, by the controller, the motor in a second direction opposite the first direction.

EEE(28) The method of operating a hedge trimmer according to EEE(27), further comprising: storing an indication of one of a next direction or a previous direction of rotation of the motor in the controller, wherein a rotational direction of the motor is determined based on the stored indication of the next direction or the stored indication of the previous direction of rotation.

EEE(29) The method of operating a hedge trimmer according to any one of EEE(27) or EEE(28), wherein the hedge trimmer further includes: a first blade including a first blade opening at a first proximal end; a second blade including a second blade opening at a second proximal end; a first cam coin including a first cam coin opening; a second cam coin including a second cam coin opening; an output gear including an output gear opening; and an output shaft including a first portion and a second portion, the first portion being wider than the first cam coin opening and the second cam coin opening, the second portion being wider than the output gear opening, wherein the first cam coin opening and the second cam coin opening are aligned to form a cam assembly, wherein the output shaft is positioned through the first cam coin opening and the second cam coin opening, and wherein the cam assembly is positioned in a perpendicular plane with respect to the second portion and is supported for rotation about an axis to rotate eccentrically with respect to the output shaft axis.

EEE(30) The method of operating a hedge trimmer according to any one of EEE(27) to EEE(29), wherein the output shaft is positioned such that the first portion supports the cam assembly, and the second portion supports the output gear.

EEE(31) The method of operating a hedge trimmer according to any one of EEE(27) to EEE(30), wherein the first cam coin and the second cam coin are positioned 180 degrees apart respective to the output shaft.

EEE(32) The method of operating a hedge trimmer according to any one of EEE(27) to EEE(31), wherein the hedge trimmer further includes: a cam cover including a cover opening; and a slide cam washer including a slide cam opening, wherein: the cover opening and the slide cam opening are aligned with the first cam coin opening and the second cam coin opening to form the cam assembly, the output shaft is positioned through the slide cam opening, the cam cover is adjacent to a surface of the first portion, the first cam coin is adjacent to the cam cover, the first proximal end of the first blade is adjacent to the first cam coin, the slide cam washer is adjacent to the first proximal end of the first blade, the second proximal end of the second blade is adjacent to the slide cam washer, the second cam coin is adjacent to the second proximal end of the second blade, and the output gear is adjacent to the second cam coin.

EEE(33) The method of operating a hedge trimmer according to any one of EEE(27) to EEE(32), wherein the cam assembly is configured to rigidly mount the first blade and the second blade to prevent disengagement of the first blade and the second blade.

EEE(34) The method of operating a hedge trimmer according to any one of EEE(27) to EEE(33), further comprising: transmitting forces generated by the motor to rotate the output shaft.

EEE(35) The method of operating a hedge trimmer according to any one of EEE(27) to EEE(34), further comprising: generating, by the trigger switch, an input signal.

EEE(36) The method of operating a hedge trimmer according to any one of EEE(27) to EEE(35), wherein the input signal includes a voltage.

EEE(37) The method of operating a hedge trimmer according to any one of EEE(27) to EEE(36), further comprising: locking, using a butterfly switch, the trigger switch.

EEE(38) The method of operating a hedge trimmer according to any one of EEE(27) to EEE(37), further comprising: supplying power to the motor from a battery pack.

EEE(39) The method of operating a hedge trimmer according to any one of EEE(27) to EEE(38), wherein the motor is mounted within a housing of the hedge trimmer.

EEE(40) The method of operating a hedge trimmer according to any one of EEE(27) to EEE(39), wherein the motor is a brushless direct current motor.

EEE(41) The method of operating a hedge trimmer according to any one of EEE(27) to EEE(40), wherein the first blade and the second blade are at least eight-inch blades.

EEE(42) The method of operating a hedge trimmer according to any one of EEE(27) to EEE(41), wherein the hedge trimmer further includes a gear case, and wherein the cam assembly is coupled to the gear case.

EEE(43) The method of operating a hedge trimmer according to any one of EEE(27) to EEE(42), wherein the hedge trimmer further includes a gear case cover coupled to the gear case, and wherein the gear case cover is formed with a material reduction pattern and includes an integrated hand hook feature.

EEE(44) The method of operating a hedge trimmer according to any one of EEE(27) to EEE(43), wherein the hedge trimmer further includes: a blade assembly coupled to the cam assembly, the blade assembly including the first blade, the second blade, a blade spine, and a plurality of bushings, wherein: the first blade and the second blade are affixed to the blade spine, and the plurality of bushings are stationary with respect to the blade spine and allow for reciprocating motion between the first blade and the second blade.

EEE(45) The method of operating a hedge trimmer according to any one of EEE(27) to EEE(44), further comprising: securing the blade assembly to the gear case via a plurality of blade mounting screws.

EEE(46) The method of operating a hedge trimmer according to any one of EEE(27) to EEE(45), wherein the blade assembly includes a peanut shaped bushing.

EEE(47) The method of operating a hedge trimmer according to any one of EEE(27) to EEE(46), further comprising: securing each of the blade mounting screws to the gear case via a respective fastener.

EEE(48) The method of operating a hedge trimmer according to any one of EEE(27) to EEE(47), wherein each of the fasteners include a hexagonal nut.

EEE(49) The method of operating a hedge trimmer according to any one of EEE(27) to EEE(48), wherein the first proximal end of the first blade and the second proximal end of the second blade each include two stacked layers and an ear portion that extends beyond the cam assembly.

EEE(50) The method of operating a hedge trimmer according to any one of EEE(27) to EEE(49), wherein the first blade and the second blade are configurable to a fanned position.

EEE(51) The method of operating a hedge trimmer according to any one of EEE(27) to EEE(50), wherein the cam assembly is configured to remain intact when the first blade and the second blade are in the fanned position.

EEE(52) The method of operating a hedge trimmer according to any one of EEE(27) to EEE(51), further comprising: protecting the first blade and the second blade using a fully enclosed blade sheath.

EEE(53) A hedge trimmer comprising: a trigger switch; an output gear; a motor coupled to the output gear, the motor configured to operate in a forward rotational direction or a reverse rotational direction; and a controller connected to the motor and comprising: one or more processors; and a non-transitory computer readable medium connected to the one or more processors and having instructions stored thereon which, when executed by the one or more processors, cause the one or more processors to: receive an input from the trigger switch, and change a rotational direction of the motor based on the input.

EEE(54) The hedge trimmer according to EEE(53), further comprising: a first blade including a first blade opening at a first proximal end; a second blade including a second blade opening at a second proximal end; a first cam coin including a first cam coin opening; a second cam coin including a second cam coin opening, wherein the output gear includes an output gear opening, and wherein the first cam coin opening, the second cam coin opening, and the output gear opening align to form a cam assembly; and an output shaft including a first portion and a second portion, the first portion being wider than the first cam coin opening and the second cam coin opening, the second portion being wider than the output gear opening, wherein the output gear is configured to transmit forces generated by the motor to rotate the output shaft, and wherein the output shaft is positioned through the first cam coin opening, the second cam coin opening, and the output gear opening, the cam assembly is positioned at a perpendicular plane with respect to the second portion, and the cam assembly is supported for rotation about an axis of the output shaft to rotate eccentrically with respect to the axis of the output axis.

EEE(55) The hedge trimmer according to any one of EEE(53) or EEE(54), wherein the output shaft is positioned such that the first portion supports the cam assembly, and the second portion supports the output gear.

EEE(56) The hedge trimmer according to any one of EEE(53) to EEE(55), wherein the first cam coin and the second cam coin are positioned 180 degrees apart respective to the output shaft.

EEE(57) The hedge trimmer according to any one of EEE(53) to EEE(56), further comprising: a cam cover including a cover opening; and a slide cam washer including a slide cam opening, wherein: the cover opening and the slide cam opening are aligned with the first cam coin opening and the second cam coin opening to form the cam assembly, the output shaft is positioned through the slide cam opening, the cam cover is adjacent to a surface of the first portion, the first cam coin is adjacent to the cam cover, the first proximal end of the first blade is adjacent to the first cam coin, the slide cam washer is adjacent to the first proximal end of the first blade, the second proximal end of the second blade is adjacent to the slide cam washer, the second cam coin is adjacent to the second proximal end of the second blade, and the output gear is adjacent to the second cam coin.

EEE(58) The hedge trimmer according to any one of EEE(53) to EEE(57), wherein the cam assembly is configured to rigidly mount the first blade and the second blade to prevent disengagement of the first blade and the second blade.

EEE(59) The hedge trimmer according to any one of EEE(53) to EEE(58), wherein the motor is couple to the output gear, and wherein the output gear is configured to transmit forces generated by the motor to rotate the output shaft.

EEE(60) The hedge trimmer according to any one of EEE(53) to EEE(59), wherein the trigger switch is configured to generate an input signal.

EEE(61) The hedge trimmer according to any one of EEE(53) to EEE(60), wherein the input signal includes a voltage.

EEE(62) The hedge trimmer according to any one of EEE(53) to EEE(61), further comprising: a butterfly switch configured to lock the trigger switch.

EEE(63) The hedge trimmer according to any one of EEE(53) to EEE(62), further comprising: a housing; and a battery pack configured to supply power to the motor.

EEE(64) The hedge trimmer according to any one of EEE(53) to EEE(63), wherein the motor is mounted within the housing.

EEE(65) The hedge trimmer according to any one of EEE(53) to EEE(64), wherein the motor is a brushless direct current motor.

EEE(66) The hedge trimmer according to any one of EEE(53) to EEE(65), wherein the first blade and the second blade are at least eight-inch blades.

EEE(67) The hedge trimmer according to any one of EEE(53) to EEE(66), further comprising: a gear case, and wherein the cam assembly is coupled to the gear case.

EEE(68) The hedge trimmer according to any one of EEE(53) to EEE(67), further comprising: a gear case cover coupled to the gear case, and wherein the gear case cover is formed with a material reduction pattern and includes an integrated hand hook feature.

EEE(69) The hedge trimmer according to any one of EEE(53) to EEE(68), further comprising: a blade assembly coupled to the cam assembly, the blade assembly including the first blade, the second blade, a blade spine, and a plurality of bushings, wherein: the first blade and the second blade are affixed to the blade spine, and the plurality of bushings are stationary with respect to the blade spine and allow for reciprocating motion between the first blade and the second blade.

EEE(70) The hedge trimmer according to any one of EEE(53) to EEE(69), wherein the blade assembly is secured to the gear case via a plurality of blade mounting screws.

EEE(71) The hedge trimmer according to any one of EEE(53) to EEE(70), wherein the blade assembly includes a peanut shaped bushing.

EEE(72) The hedge trimmer according to any one of EEE(53) to EEE(71), wherein each of the blade mounting screws are secured to the gear case via a respective fastener.

EEE(73) The hedge trimmer according to any one of EEE(53) to EEE(72), wherein each of the fasteners includes a hexagonal nut.

EEE(74) The hedge trimmer according to any one of EEE(53) to EEE(73), wherein the first proximal end of the first blade and the second proximal end of the second blade each include two stacked layers and an ear portion that extends beyond the cam assembly.

EEE(75) The hedge trimmer according to any one of EEE(53) to EEE(74), wherein the first blade and the second blade are configurable to a fanned position.

EEE(76) The hedge trimmer according to any one of EEE(53) to EEE(75), wherein the cam assembly is configured to remain intact when the first blade and the second blade are in the fanned position.

EEE(77) The hedge trimmer according to any one of EEE(53) to EEE(76), further comprising a fully enclosed blade sheath to protect the first blade and the second blade.

What is claimed is:

1. A hedge trimmer comprising:
a first blade including a first blade opening at a first proximal end;
a second blade including a second blade opening at a second proximal end;
a first cam coin including a first cam coin opening;
a second cam coin including a second cam coin opening;
an output gear including an output gear opening; and
an output shaft including a first portion and a second portion, the first portion being wider than the first cam coin opening and the second cam coin opening, the second portion being wider than the output gear opening,
wherein the first cam coin opening and the second cam coin opening are aligned to form a cam assembly,
wherein the output shaft is positioned through the first cam coin opening and the second cam coin opening, and
wherein the cam assembly is positioned in a perpendicular plane with respect to the second portion and is supported for rotation about an axis to rotate eccentrically with respect to the output shaft axis.

2. The hedge trimmer of claim 1, wherein the output shaft is positioned such that the first portion supports the cam assembly and the second portion supports the output gear.

3. The hedge trimmer of claim 2, wherein the first cam coin and the second cam coin are positioned 180 degrees apart respective to the output shaft.

4. The hedge trimmer of claim 2, further comprising:
a cam cover including a cover opening; and
a slide cam washer including a slide cam opening, wherein:
the cover opening and the slide cam opening are aligned with the first cam coin opening and the second cam coin opening to form the cam assembly,
the output shaft is positioned through the slide cam opening,
the cam cover is adjacent to a surface of the first portion,
the first cam coin is adjacent to the cam cover,
the first proximal end of the first blade is adjacent to the first cam coin,
the slide cam washer is adjacent to the first proximal end of the first blade,
the second proximal end of the second blade is adjacent to the slide cam washer,
the second cam coin is adjacent to the second proximal end of the second blade, and
the output gear is adjacent to the second cam coin.

5. The hedge trimmer of claim 1, wherein the cam assembly is configured to rigidly mount the first blade and the second blade to prevent disengagement of the first blade and the second blade.

6. The hedge trimmer of claim 1, further comprising:
a housing;
a motor mounted to the housing and coupled to the output gear; and
a battery pack configured to supply power to the motor, wherein the output gear is configured to transmit forces generated by the motor to rotate the output shaft.

7. The hedge trimmer of claim 6, further comprising:
a trigger switch configured to generate an input signal; and
a butterfly switch configured to lock the trigger switch, wherein the motor is configured to operate in a forward rotational direction or a reverse rotational direction, and wherein the motor is configured to alternate between the forward rotational direction and the reverse rotational direction based on the input signal.

8. The hedge trimmer of claim 7, further comprising:
a controller connected to the motor and including:
one or more processors; and
a non-transitory computer readable medium connected to the one or more processors and having instructions stored thereon which, when executed by the one or more processors, cause the one or more processors to:
receive the input signal, and
alternate a rotational direction of the motor based on the input signal.

9. The hedge trimmer of claim 1, further comprising:
a gear case; and
a gear case cover coupled to the gear case, wherein the cam assembly is coupled to the gear case, and wherein the gear case cover is formed with a material reduction pattern and includes an integrated hand hook feature.

10. The hedge trimmer of claim 9 further comprising:
a blade assembly coupled to the cam assembly, the blade assembly including the first blade, the second blade, a blade spine, and a plurality of bushings, wherein:
the first blade and the second blade are affixed to the blade spine, and
the plurality of bushings are stationary with respect to the blade spine and allow for reciprocating motion between the first blade and the second blade.

11. The hedge trimmer of claim 10, wherein the blade assembly is secured to the gear case via a plurality of blade mounting screws, and wherein the blade assembly includes a peanut-shaped bushing.

12. The hedge trimmer of claim 11, wherein each of the blade mounting screws is secured to the gear case via a respective fastener.

13. The hedge trimmer of claim 12, wherein each of the fasteners include a hexagonal nut.

14. The hedge trimmer of claim 1, wherein the first proximal end of the first blade and the second proximal end of the second blade each include two stacked layers and an ear portion that extends beyond the cam assembly.

15. The hedge trimmer of claim 1, wherein the first blade and the second blade are configurable to a fanned position.

16. The hedge trimmer of claim 15, wherein the cam assembly is configured to remain intact when the first blade and the second blade are in the fanned position.

17. The hedge trimmer of claim 1, further comprising:
a fully-enclosed blade sheath to protect the first blade and the second blade.

18. A method of operating a hedge trimmer, the hedge trimmer including a trigger switch and a motor, the method comprising:
detecting, by a controller, a first actuation of the trigger switch;
rotating, by the controller, the motor in a first direction;
detecting, by the controller, a release of the trigger switch;
stopping the rotation of the motor;
detecting, by the controller, a second actuation of the trigger switch; and
rotating, by the controller, the motor in a second direction opposite the first direction.

19. The method of claim 18, further comprising:
storing an indication of one of a next direction or a previous direction of rotation of the motor in the controller, wherein a rotational direction of the motor is determined based on the stored indication of the next direction or the stored indication of the previous direction of rotation.

20. A hedge trimmer comprising:
a trigger switch;
an output gear;
a motor coupled to the output gear, the motor configured to operate in a forward rotational direction or a reverse rotational direction; and
a controller connected to the motor and comprising:
one or more processors; and
a non-transitory computer readable medium connected to the one or more processors and having instructions stored thereon which, when executed by the one or more processors, cause the one or more processors to:
receive an input from the trigger switch, and
change a rotational direction of the motor based on the input.
